(19) United States
(12) Patent Application Publication
(10) Pub. No.: US 2026/0196367 A1
(43) Pub. Date: Jul. 9, 2026

(54) Fusion plasma loop voltage control method based on reinforcement learning

(71) Applicant: HEFEI COMPREHENSIVE NATIONAL SCIENCE CENTER ENERGY RESEARCH INSTITUTE (ANHUI ENERGY LABORATORY), Hefei (CN)

(72) Inventors: Zijie LIU, Hefei (CN); Bingjia XIAO, Hefei (CN); Junjie HUANG, Hefei (CN); Shaoqing LIU, Hefei (CN); Heru GUO, Hefei (CN)

(73) Assignee: HEFEI COMPREHENSIVE NATIONAL SCIENCE CENTER ENERGY RESEARCH INSTITUTE (ANHUI ENERGY LABORATORY), Hefei (CN)

(21) Appl. No.: 19/147,213

(22) PCT Filed: Jun. 6, 2025
(86) PCT No.: PCT/CN2025/099500

§ 371 Date: Jul. 10, 2025

(30) Foreign Application Priority Data
Jul. 30, 2024 (CN) 202411032059.9

(51) Int. Cl. G21B 1/21; G06N 3/0442; G06N 3/092; G21B 1/05

(52) U.S. Cl. CPC G21B 1/21; G06N 3/0442; G06N 3/092; G21B 1/057

(57) ABSTRACT

The present invention relates to the field of fusion plasma control technology, and in particular to a fusion plasma loop voltage control method based on reinforcement learning, comprising following steps: selecting data of a training model: in a background of Tokamak fusion plasma, taking plasma parameters at a current moment as input, and output as vloop at a next moment; constructing a database: collecting discharge data of a running Tokamak device and discharge data in an early stage of a future device as initial training data for building a model. The present invention improves the accuracy and response speed of the Tokamak vloop control algorithm, strengthens the self-learning and self-adaptation capabilities of the learning model, improves the long-term stability and optimization effect of the vloop control method in the Tokamak system, improves the overall control effect, reduces the need for manual intervention and operation, reduces operating costs and human resource investment, and is of great significance for achieving controlled nuclear fusion.

### TECHNICAL FIELD

The present invention relates to the technical field of fusion plasma control, and in particular to a fusion plasma loop voltage control method based on reinforcement learning.

### BACKGROUND TECHNOLOGY

The Tokamak device is an important device for studying and realizing nuclear fusion reactions with a working principle of confining high-temperature plasma through a strong magnetic field, so that it can undergo nuclear fusion reactions under high temperature and high pressure. The control of a Tokamak system is crucial to achieving a stable plasma state and effective nuclear fusion reactions. In a Tokamak control system, vloop is a key parameter that directly affects the stability and confinement effect of the plasma.

The control of the Tokamak system has following disadvantages:
(1) Insufficient nonlinear response: The Tokamak system has highly nonlinear and complex dynamic characteristics. Traditional vloop control usually uses a PID controller, but this method is difficult to maintain good control effects under various operating conditions, resulting in insufficient control accuracy and stability.
(2) Parameter adjustment depends on experience: Parameters of the PID controller need to be manually adjusted through human experience, lacking automatic adjustment capabilities and difficult to adapt to rapid changes and complex conditions in Tokamak environment.
(3) Short-term optimization limitations: The PID controller mainly focuses on error adjustment at the current moment and cannot optimize the control performance of the long period, resulting in limited long-term stability and optimization effect of the system.
(4) Difficulty in high-dimensional state processing: Tokamak vloop control involves multiple high-dimensional state parameters. Traditional PID controllers are difficult to process these complex parameters at the same time, resulting in unsatisfactory overall control effects.

In summary, the present application proposes a fusion plasma loop voltage control method based on reinforcement learning.

### SUMMARY OF THE INVENTION

The purpose of the present invention is to propose a fusion plasma loop voltage control method based on reinforcement learning in response to a problem that control effects of Tokamak vloop control in nonlinear and complex dynamic environments are generally poor.

The technical solution of the present invention provides a fusion plasma loop voltage control method based on reinforcement learning, comprising following steps:
selecting data of a training model: in a background of Tokamak fusion plasma, taking plasma parameters at a current moment as input, and output as vloop at a next moment;
constructing a database: collecting discharge data of a running Tokamak device and discharge data in an early stage of a future device as initial training data for building a model;
constructing a neural network model: using a long short-term memory neural network as the training model, and determining quantities of layers and neurons of LSTM neural network according to a specific training process;
training the neural network model: building and training the model based on a mainstream framework, and adjusting a network structure according to predicted results;
testing the neural network model: preparing new data except training data for model testing, judging whether the model is effective by comparing differences between the predicted results and real results, conducting multi-step reasoning verification, and ensuring that the predicted results of such process are consistent with experimental data;
constructing a reinforcement learning model: adopting a proximal policy optimization algorithm;
reinforcement learning training: taking a trained response model as interactive environment of reinforcement learning, setting an exploration range according to abilities of LHW, and determining an optimal control command within a specified range;
testing the reinforcement learning model: adding a certain amount of noise to a current state, using a reinforcement learning controller to issue control commands based on the current state, inputting the control commands into response environment, and checking control effects; and
replacing a current loop voltage controller: after meeting control requirements, replacing a traditional vloop control algorithm with a trained model and according to requirements of vloop control, providing LHW power signals in real time to achieve precise control of vloop by collecting signals in real time.

Optionally, the LSTM neural network is a special type of recurrent neural network (RNN) for processing sequential data and time-series tasks, and constitutes a deep network through stacking of a plurality of LSTM units, with a hidden state of each unit serving as an input for the next moment to efficiently process long-term dependencies and capture contextual information further down the line.

Optionally, the proximal policy optimization algorithm (PPO) has a goal of maximizing performance at each policy update and ensuring stability of policy optimization by limiting magnitude of policy updates.

Optionally, the plasma parameters comprise total plasma current, longitudinal field coil current, PF coil current, average density of plasma electron strings, poloidal beta, plasma internal inductance, energy storage, plasma boundary, radiant power, vloop, plasma boundary, auxiliary heating ECRH power, auxiliary heating ICRF power, and auxiliary heating LHW power.

Optionally, the mainstream framework is a tensorflow framework or a Pytorch framework.

Optionally, in the step of training the neural network model, an error of the predicted results is less than 3%.

Optionally, in the step of constructing a reinforcement learning model, a policy gradient optimization algorithm is used.

Optionally, in the step of testing the neural network model, a number of inference steps is arranged to be 100.

In summary, the present application boasts for at least one of following beneficial technical effects:
(1) Improving the accuracy and response speed of a Tokamak vloop control algorithm:
   By introducing a deep reinforcement learning algorithm and a proxy model, the present invention significantly improves the accuracy and response speed of the Tokamak vloop control. The reinforcement learning algorithm can adaptively adjust a control strategy under complex and nonlinear dynamic conditions, so that the vloop can track target values more accurately.
(2) Enhancing adaptive capabilities of a system:
   The reinforcement learning model has an ability to self-learn and adapt, and can automatically optimize the control strategy according to real-time environmental changes, reducing reliance on human intervention and manual adjustment of parameters. The system can quickly adapt to different operating conditions and emergencies, improving intelligence levels of the Tokamak control system.
(3) Optimizing long-term control effects:
   By designing a reasonable reward function, the reinforcement learning model can not only optimize the control effects in a short term, but also maintain good control performance in a long term, which significantly improves the long-term stability and optimization effect of a vloop control method in the Tokamak system, ensuring continuous and stable nuclear fusion experimental conditions.
(4) Efficient processing of high-dimensional state parameters:
   The present invention utilizes a powerful feature extraction capability of deep neural networks to effectively process high-dimensional and complex state parameters in the Tokamak system, thereby improving an overall control effect. The proxy model can provide accurate vloop predictions, providing a more accurate basis for the reinforcement learning controller.
(5) Reducing manual intervention and operating costs:
   Since the present invention mentions that the vloop control method based on reinforcement learning has the ability to adapt and automatically adjust, it reduces the need for manual intervention and operation, and reduces operating costs and human resource investment. The control system can automatically optimize and adjust parameters, which improves convenience and efficiency of operation.
(6) Promoting a progress of nuclear fusion research:
   The control method of the present invention can be extended to other control systems in the field of fusion, significantly improving performance of the Tokamak control system, and providing a more stable and accurate control method for nuclear fusion experiments. This is of great significance to the realization of controlled nuclear fusion, promotes the progress of nuclear fusion research, and provides technical support for future energy development.

By introducing a reinforcement learning algorithm to replace a traditional PID controller, the present invention realizes more accurate and adaptive vloop control in Tokamak system, improves the precision, response speed and long-term stability of the control system, and overcomes the deficiencies of the traditional controller in nonlinear and complex dynamic environments.

### BRIEF DESCRIPTION OF THE DRAWINGS

FIG. 1 is a schematic diagram of interactions between reinforcement learning and neural networks;

FIG. 2 is a schematic diagram of construction steps of a reinforcement learning controller according to the present invention.

### SPECIFIC EMBODIMENTS

The technical solution of the present application will be clearly and completely described below in conjunction with the accompanying drawings. Obviously, the described embodiments are part of the embodiments of the present application, rather than all of the embodiments. The components of the embodiments of the present application usually described and shown in the accompanying drawings can be arranged and designed in various different configurations. Therefore, the following detailed description of the embodiments of the present application provided in the accompanying drawings is not intended to limit the scope of the application claimed for protection, but merely represents the selected embodiments of the present application. Based on the embodiments in the present application, all other embodiments obtained by ordinary technicians of the art without making creative work fall within the scope of protection of the present application.

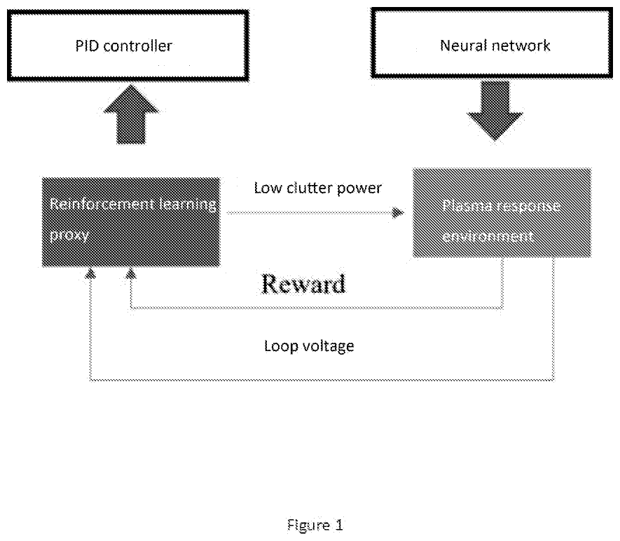

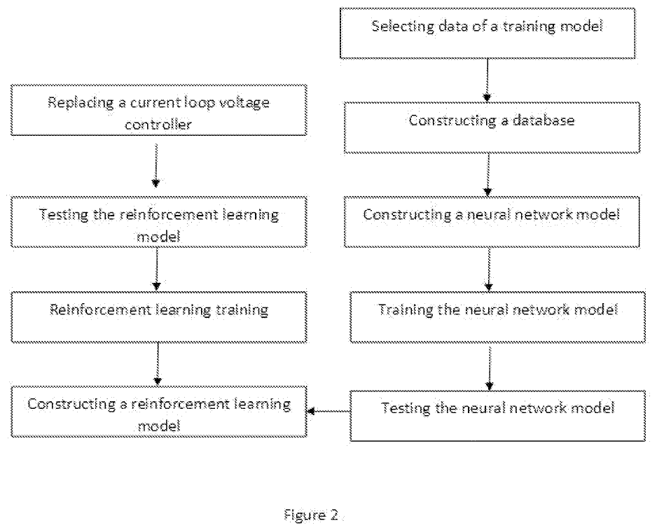

The present invention will utilize neural networks to construct a plasma response environment, and then interact with the response environment through reinforcement learning to obtain a vloop controller. In an experiment of LHW power controlling vloop, LHW driving current is affected by several factors, and it is difficult to accurately define a relationship between these two by traditional methods. The present invention uses data-driven and neural network-based construction of a response model to summarize the relationship between LHW power and vloop, and then explores optimal control commands for controlling the vloop in the current state through reinforcement learning, with a schematic diagram of the process shown in FIG. 1 and the specific construction steps shown in FIG. 2.

### 1. Selecting Data of a Training Model

In a context of Tokamak fusion plasma, factors of LHW driving current controlling vloop are fully considered, and plasma parameters at the current moment, including total plasma current, longitudinal field coil current, PF coil current, average density of plasma electron strings, poloidal beta, plasma internal inductance, energy storage, plasma boundary, radiation power, vloop, plasma boundary, auxiliary heating ECRH power, auxiliary heating ICRF power, and auxiliary heating LHW power, are taken as input, and the output is vloop at the next moment.

### 2. Constructing a Database

After inputs and outputs of the model have been determined, data need to be collected to construct a database. The data from the Tokamak discharges are stored and can be directly selected from existing data. Some discharges will be attempted in early stages of a future device, and these data can also be obtained as initial training data.

### 3. Constructing a Neural Network Model

Due to a cumulative effect of some parameters over time, a long short-term memory (LSTM) neural network is considered to be applied as a training model. The LSTM neural network is a special type of recurrent neural network (RNN) used to process sequential data and time-series tasks. The LSTM network is constructed as a deep network through stacking of multiple LSTM units, where a hidden state of each unit serves as an input for the next time input. In this way, LSTM can effectively deal with long-term dependencies, allowing the network to capture contextual information further down the line. Quantities of layers and neurons of LSTM neural network can be determined according to the specific training process.

### 4. Training the Neural Network Model

The model can be built and trained based on the current mainstream frameworks, such as tensorflow, Pytorch, etc. One of the frameworks is selected to build the model, and then the data is put into the model for training. During the training process, the network structure needs to be adjusted according to the predicted results so that an error of the predicted results is less than 3%.

### 5. Testing the Neural Network Model

In addition to the data used for training, some data should be prepared for testing the model. New data is fed into the model to compare differences between the predicted results and actual results to determine if the model is valid. This process requires multi-step reasoning verification, i.e., the vloop obtained by inputting the current data is used as the input for the second step of the prediction process, and so on, which requires about 100 steps of inference and ensures that the predicted results of this process are consistent with experimental data.

### 6. Constructing a Reinforcement Learning Model

The plasma parameters generally do not vary significantly during Tokamak discharges, so a proximal policy optimization (PPO) algorithm is considered. A goal of the PPO is to maximize performance of each policy update and to ensure the stability of the policy optimization by limiting the magnitude of the policy update. The PPO algorithm is a powerful and flexible policy optimization algorithm, with good convergence, stability and sample efficiency. It is widely used in practice and has achieved good performance in many reinforcement learning tasks. Other algorithms can also be considered in this process, such as policy gradient.

### 7. Reinforcement Learning Training

A trained response model is used as interactive environment for reinforcement learning and the reinforcement learning model is trained. In the training process, it is necessary to set an exploration range according to capabilities of the LHW, and determine an optimal control command within a specified range.

### 8. Testing the Reinforcement Learning Model

A certain amount of noise is added to the current state, and then a reinforcement learning controller is utilized to give control commands based on the current state, and the control commands are input into the response environment to see the effect of control.

### 9. Replacing a Current Loop Voltage Controller

After completing the test in step 8, the trained model can be used to replace the traditional vloop control algorithm if the control requirements are met. By collecting signals in real time and providing LHW power signals in real time according to the requirements of vloop control, accurate control of vloop can be achieved.

In order to verify the technical effect of the present invention, implementation verification is carried out.

The present invention provides following embodiments:
1. Response environment: The response environment uses the LSTM neural network, which contains three hidden layers, and the number of neurons in each hidden layer is 30, 20, and 10. The neural network model is based on Python language, the model framework is based on PyTorch, and GPU is deployed for model training. Based on discharge data of 1835 cannons in a fusion discharge experiment, 1600 cannons data is used as a training set, 200 cannons data is used as a validation set, and 35 cannons data is used as a test set.
2. Controller: The controller uses the POP reinforcement learning algorithm and is built based on the Python language. In this environment, the control command of reinforcement learning is input to the neural network model, and the neural network model gives response results. The model training is stopped by continuously exploring to reach a convergence condition, which is to maximize a cumulative reward. In addition, during the training process, a maximum number of iterations is set and the model is stopped if the maximum number of iterations is reached.

Beneficial effects:
1. Fast response environment: A neural network-based response environment can give fast and accurate predicted results.

The model predicts once in 1 millisecond, and similarity of prediction reaches 97.5%. The fast response environment ensures fast training for strong chemical training, reducing training time and cost.
2. Superior control effect: The vloop controller based on reinforcement learning can control the vloop better, and given LHW power is smaller than that of the traditional controller, obtaining better control with minimum cost.
3. Integrated environment: Both the response environment and the control are developed based on python environment, which makes the interaction between models easier and the training faster, and reduces the cost of controller design.

This implementation example demonstrates the specific structure and effect of the vloop controller provided by the present invention. Through a combination of a neural network and reinforcement learning, accurate control of vloop is achieved, which makes up for deficiencies of traditional controllers and improves control performance of vloop.

The above specific embodiments are only several optional embodiments of the present invention. Based on the technical solutions of the present invention and the relevant enlightenment of the above embodiments, those skilled in the art can make various alternative improvements and combinations to the above specific embodiments.

What is claimed is:

1. A fusion plasma loop voltage control method based on reinforcement learning, comprising following steps:
selecting data of a training model: in a background of Tokamak fusion plasma, taking plasma parameters at a current moment as input, and output as vloop at a next moment;
constructing a database: collecting discharge data of a running Tokamak device and discharge data in an early stage of a future device as initial training data for building a model;
constructing a neural network model: using a long short-term memory neural network as the training model, and determining quantities of layers and neurons of LSTM neural network according to a specific training process;
training the neural network model: building and training the model based on a mainstream framework, and adjusting a network structure according to predicted results;
testing the neural network model: preparing new data except training data for model testing, judging whether the model is effective by comparing differences between the predicted results and real results, conducting multi-step reasoning verification, and ensuring that the predicted results of such process are consistent with experimental data;
constructing a reinforcement learning model: adopting a proximal policy optimization algorithm;
reinforcement learning training: taking a trained response model as interactive environment of reinforcement learning, setting an exploration range according to abilities of LHW, and determining an optimal control command within a specified range;
testing the reinforcement learning model: adding a certain amount of noise to a current state, using a reinforcement learning controller to issue control commands based on the current state, inputting the control commands into response environment, and checking control effects; and
replacing a current loop voltage controller: after meeting control requirements, replacing a traditional vloop control algorithm with a trained model and according to requirements of vloop control, providing LHW power signals in real time to achieve precise control of vloop by collecting signals in real time.

2. The fusion plasma loop voltage control method based on reinforcement learning according to claim 1, wherein the LSTM neural network is a special type of recurrent neural network (RNN) for processing sequential data and time-series tasks, and constitutes a deep network through stacking of a plurality of LSTM units, with a hidden state of each unit serving as an input for the next moment to efficiently process long-term dependencies and capture contextual information further down the line.

3. The fusion plasma loop voltage control method based on reinforcement learning according to claim 1, wherein the proximal policy optimization algorithm (PPO) has a goal of maximizing performance at each policy update and ensuring stability of policy optimization by limiting magnitude of policy updates.

4. The fusion plasma loop voltage control method based on reinforcement learning according to claim 1, wherein the plasma parameters comprise total plasma current, longitudinal field coil current, PF coil current, average density of plasma electron strings, poloidal beta, plasma internal inductance, energy storage, plasma boundary, radiant power, vloop, plasma boundary, auxiliary heating ECRH power, auxiliary heating ICRF power, and auxiliary heating LHW power.

5. The fusion plasma loop voltage control method based on reinforcement learning according to claim 1, wherein the mainstream framework is a tensorflow framework or a Pytorch framework.

6. The fusion plasma loop voltage control method based on reinforcement learning according to claim 1, wherein in the step of training the neural network model, an error of the predicted results is less than 3%.

7. The fusion plasma loop voltage control method based on reinforcement learning according to claim 1, wherein in the step of constructing a reinforcement learning model, a policy gradient optimization algorithm is used.

8. The fusion plasma loop voltage control method based on reinforcement learning according to claim 1, wherein in the step of testing the neural network model, a number of inference steps is arranged to be 100.
